(19) United States
(12) Patent Application Publication
(10) Pub. No.: US 2023/0278837 A1
(43) Pub. Date: Sep. 7, 2023

(54) DEVICE FOR MOVING AN ARTICLE

(71) Applicant: SITA B.V., Rotterdam (NL)

(72) Inventors: Alexandros Vangelis PLIAKIS, Rotterdam (NL); Mathieu Eduard KEIZER, Rotterdam (NL); Swen van KLAARBERGEN, Rotterdam (NL)

(21) Appl. No.: 18/316,738

(22) Filed: May 12, 2023

Related U.S. Application Data
(63) Continuation of application No. PCT/EP2021/081858, filed on Nov. 16, 2021.

(30) Foreign Application Priority Data
Nov. 16, 2020 (GB) 2017980.0

(51) Int. Cl. B66F 9/065

(52) U.S. Cl. CPC B66F 9/065

(57) ABSTRACT

A device for moving an article between a first position and a second position, the device comprising: a support portion for supporting an article; one or more wheels; and at least one actuator mechanism coupled to the support portion and the one or more wheels. The at least one actuator mechanism is configured to move the support portion between a first position and a second position, wherein the first position is offset from the second position such that the support portion is raised relative to the one or more wheels when moved from the first position to the second position to allow at least a portion of the one or more wheels to protrude beyond a plane defined by the support portion.

### CROSS REFERENCE TO RELATED APPLICATIONS

This application is a continuation of International Patent Application No. PCT/EP2021/081858, filed on Nov. 16, 2021 and entitled “DEVICE FOR MOVING AN ARTICLE,” which claims the benefit of and priority of Great Britain Patent Application No. 2017980.0, filed Nov. 16, 2020 and entitled “Device for moving an article,” which are each incorporated by reference herein in their entireties.

### FIELD OF THE INVENTION

This invention relates to a device for moving an article between a first position and a second position. More particularly, this invention relates to a device for moving large and heavy articles between a first position and a second position. Even more specifically, this invention relates to a device for moving kiosks or electronic devices for communicating with customers or users by moving the kiosk or electronic device from a first position to a second position such that the kiosk or electronic device may be relocated.

Even more specifically, this invention relates to a device for moving kiosks such as check-in kiosks and other electronic devices between locations at a transportation hub, such as an airport or train station and so on.

The invention also relates to a method of coupling the device to a kiosk.

### BACKGROUND OF THE INVENTION

Articles such as kiosks or electronic devices situated at transportation hubs are typically large and heavy. That is, they are typically difficult and unsafe to move manually, and their relocation is inefficient.

Taking an airport kiosk as an example article, airports must cope with capacity issues. Peak capacity demands vary throughout the airport. However, currently, kiosks are typically static (that is, they cannot practically, efficiently, and safely be moved). They are typically fixed to the ground or are too heavy to be moved manually, and as such they cannot be where they are most needed. When such kiosks are moved, the process is cumbersome, inefficient, and often requires multiple users. A wide range of kiosks are currently installed at transportation hubs such as airports and the kiosk locations are relatively fixed.

### SUMMARY OF THE INVENTION

The inventors of the present invention have appreciated the need to be able to relocate articles such as kiosks or electronic devices at a transportation hub. The inventors have therefore appreciated the need for a device for moving or relocating an article, and in particular, the need for the device to be capable of being retrofitted to existing articles.

Arrangements of the present invention enable the provision of a battery powered, retrofittable self-service kiosk mobility module for transit services.

The invention is defined by the independent claims to which reference should now be made. Optional features are set forth in the dependent claims.

It is advantageous to be able to move articles such as kiosks. It may be desired that articles or kiosks are moved or relocated for a plurality of reasons. Kiosks may be moved from one location to another to counter a change in required capacity, for example, during seasonal peaks. Kiosks can be moved from an initial or “regular” location to another location to encounter a seasonal peak. A “regular” location may be a location at which a kiosk is most commonly or mainly located. This location may include a location in, for example, a terminal, or in storage. Kiosks may also be moved to address changes in capacity requirements on specific days of the week. For example, weekends or days with recurring events (such as sports games, festivals etc.). This means that the kiosks may be moved from their “regular” location or terminal to where the peak is expected. Kiosks may also be moved to address peak hour(s) for certain locations or, for example, airlines in an airport. This can be unexpected peak hours (for example, due to shortage of staff, power outage, or machine failure). When this happens, according to the present invention, kiosks can be moved from their regular place to where the peak is located. The present invention is advantageous in that it can provide such fast mobility which enables adaptation to changes in capacity requirements.

By providing mobility to an article, an article owner or customer is able to deploy the article anywhere they like, for example, in an airport. To help enable this mobility, the article may not be connected to a power grid or to a network via a wired connection such as an Ethernet port. It may be preferable that the article is independent of any such contact point.

According to an aspect of the present invention, there is provided a device for moving an article between a first position and a second position, the device comprising: a support portion for supporting an article; one or more wheels; and at least one actuator mechanism coupled to the support portion and the one or more wheels, the at least one actuator mechanism being configured to move the support portion between a first position and a second position, wherein the first position is offset from the second position such that the support portion is raised relative to the one or more wheels when moved from the first position to the second position to allow at least a portion of the one or more wheels to protrude beyond a plane defined by the support portion.

As will be explained in great detail below, by moving the support portion to the second position, the device and article are raised onto the one or more wheels and are able to be moved or relocated using the one or more wheels.

The article may be an electronic device, which may be any suitable electronic device. In particular, the article may be a kiosk or electronic device, such as a kiosk located at a transportation hub. A transportation hub may include an airport, a train station, or similar location.

The support portion may be a base plate. The support portion is configured to support an article which is to be moved from the first position to the second position. That is, the article is supported by, or rests on, the support portion. The footprint of the support portion is greater than the footprint of the article. Preferably the footprint of the support portion is sufficiently greater than the footprint of the article, such that one or more side portions may be located on the support portion.

Preferably, a ratio between the width of each side member 14 and the width of the support portion 12 is between around 0.15 and ⅓.

In a specific embodiment each side member 14 may have a width of approximately 120 mm. Further, the width of the article 10 may be approximately 270 mm. Further, the support portion may have a width of approximately 670 mm.

Accordingly, a ratio between the width of each side member 14 and the width of the support portion 12 may be approximately =120/670=0.18.

Preferably, a ratio between the width of the article 10 and the width of the support portion 12 is between approximately ⅓ and approximately 1 Further, in a specific embodiment, if the article has a width of approximately 270 mm and if the support portion 12 has a width of approximately 670 mm, the ratio of the width of the article 10 to the width of the support portion is approximately =270/670=0.4.

The first position may be a rest position. To secure the article, the article may be secured to the support portion, and/or to the floor. For example, the article may be coupled to the support portion with screws, or coupled to the floor or ground or other surface with screws, or any combination of such couplings. The support portion may be substantially flat. In other words, when the article is supported by the support portion, the resultant height of the article is negligibly higher than when not supported by or on the support portion. This ensures that relevant safety considerations and standards may be complied with even when the article is supported by the support portion, such as height restrictions. Any relevant stability requirements may be met when the support portion is in the first position, but do not necessarily need to be met when in the second position. The support portion may replace an existing base or support portion of an article when installed. The support portion may be the only point of physical contact between the device and the article (this may be besides any electrical connection such as a wired connection).

In some embodiments, the hinge bracket 24 is coupled to the support portion 12 and wherein each side member 14 is coupled to the hinge bracket 24 via a pivot and preferably wherein the axis of rotation of each wheel is offset from the axis of rotation of the pivot.

The support portion may comprise one or more apertures. The apertures may be configured to allow the one or more wheels to extend through or beyond the plane defined by the support portion. The support portion may comprise one aperture corresponding to each of the one or more wheels. For example, where the one or more wheels comprises four wheels, the support portion may comprise four apertures. The apertures may be of the same shape, or may have a shape depending on the size and type of the wheel. For example, where a wheel of the one or more wheels is a caster wheel intended to swivel, the corresponding aperture may be substantially circular. Where a wheel of the one or more wheels is a fixed wheel not intended to swivel, the corresponding aperture may be elongate, for example a rectangular slit.

The at least one actuator mechanism is configured to move the base plate, relative to the one or more wheels, between a first position to a second position. The at least one actuator mechanism may move the support portion relative to the one or more wheels from the first position to the second position, and from the second position to the first position. In other words, the device may be configured to lift the article on the support portion from a resting position on the ground, onto the one or more wheels. The device may then be configured to return the article and the support portion to the ground having been lifted onto the one or more wheels. The at least one actuator mechanism may be configured to move the support portion, or to move the one or more wheels such that the support portion moves relative to the one or more wheels.

The actuator mechanism may drive movement of the support portion, or of the one or more wheels. Where the one or more wheels comprise a plurality of wheels, the actuator mechanism may drive movement of one or more of the plurality of wheels. That is, all of the wheels may move relative to the support portion, but the actuator mechanism may only drive movement to one or more of the wheels. The actuator may move the support portion, and the one or more wheels may be stationary, although it will be appreciated that the relative motion between the support portion and the one or more wheels would be equivalent. The first and second positions may be such that, in the first position, the one or more wheels do not protrude beyond the plane defined by the support portion, and in the second position, at least a portion of the one or more wheels protrudes beyond the plane defined by the support portion. In this way, when in the first position, the support portion may rest on the ground whilst supporting the article. In the second position, the support portion may be raised away from the ground, and the one or more wheels are in contract with the ground. The support portion may be raised such that there is minimal horizontal motion, to reduce the likelihood of the article tipping and result in a more compact structure. Here, the ground may be considered to be any surface on which the article may typically rest or be located. The travel of the actuator mechanism may be chosen in order to achieve sufficient clearance when the support portion is in the second position such that the article and device may be moved on the one or more wheels. The distance between the first position and the second position may be relatively small, for example between 20 mm and 70 mm, such as 30 mm. In other words, during use, the support portion and therefore the article may be raised by the distance such as 30 mm when moving from the first position to the second position. By only moving a small distance, the safety of the device is improved as the likelihood of the article tipping is reduced.

The actuator mechanism may comprise a piston or piston portion. The piston portion may be configured to drive the movement of the actuator. Alternatively, the device may comprise the piston, and the piston may be separate to the actuator mechanism. The actuator mechanism may remain relatively stationary whilst the piston moves and provides movement of the support portion relative to the one or more wheels. Alternatively, the actuator mechanism may comprise a linear screw actuator. The linear screw actuator may be in connection with the support portion and/or the one or more wheels. The actuator mechanism may drive rotation of a nut along a lead screw converting rotary motion into linear motion in order to move the support portion between the first position and the second position. When the support portion is in the first position, the linear screw actuator may be in a retracted position at which the nut may be fully or substantially screwed onto the lead screw. When the support portion is moved to the second position, the linear screw actuator may be in an extended position at which the nut is at least partially unscrewed from the lead screw. The linear screw actuator may be housed in a housing. Movement of the linear screw actuator may be provided by an electric motor.

The device may comprise a locking mechanism to lock the support portion in the second position once the actuator mechanism has moved the support portion relative to the one or more wheels from the first position to the second position. The locking may be provided by the linear screw actuator. That is, the nut may have enough friction with the lead screw such that the nut will not rotate without being driven, for example by the electric motor. Therefore, once the linear screw actuator has moved the support portion to the second position, the support portion may remain in the second position until rotation of the nut is driven. This removes the need for a constant supply of power to retain the support portion in the second position.

The at least one actuator mechanism may be powered by an electrical power supply. Therefore, advantageously, an operator of the device is relieved of most physical effort, which not only is more convenient for a user but also is safer. The power supply may be a 24V electrical power supply. The power supply may be a DC power supply. The electrical power supply may be provided by a battery. This is advantageous because the article may be relocated to a location without an external power supply available. Alternatively or in addition, the at least one actuator mechanism may receive a power supply from the article being supported. Alternatively or in addition, the at least one actuator mechanism may receive power supply from an external power source, such as an AC or DC power source. The battery may be housed in a housing member. The housing member may be located towards the rear of the device.

The battery may also or alternatively provide power to the article. As such, the device may comprise an uninterruptible power supply. Advantageously, the article can be powered by the battery or uninterruptible power supply such that the article does not need to be switched off or shut down during its relocation. The power supply from the battery may be such that the article is powered by the battery for an extended period of time, such as for multiple hours, and not just powered during the relocation of the article.

The at least one actuator mechanism may be controlled by user input to control movement of the support portion between the first and second positions. For example, a user input to control the at least one actuator mechanism may be input on the device itself, or may be input on the article. In this embodiment, a direct electrical connection may be established between the device and article, and/or a wireless connection may be established between the device and the article.

In typical prior art arrangements, moving a kiosk from one place to another requires a lot of human effort. This may include: unplugging and dismounting the kiosk; lifting and moving the 100+ kg kiosk; and rewiring for power and internet at the desired location. In addition, this takes a considerable amount of time. Not only is this inefficient, but the time taken would exceed the narrow timeframe in which a response to the extra capacity required is needed. The device according to the present invention allows the kiosks to be moveable and operable at any time as they have their own lifting solution.

As explained, whilst the support portion is in the second position, the one or more wheels may be in contact with the ground or comparable surface. Whilst this is the position, the device (and therefore the article), may be relocated conveniently. The second position may be a transportation or relocation position. The article may be moved between a third position and a fourth position. The third position may be the starting location of the article, and the fourth position may be the end location of the article after having been moved. The provision of the one or more wheels allows the device and article to be moved once in the second position. The article may be moved by physical input from a user, for example, pushing or pulling the article and device. The article may be transported both short and long-distances with minimal effort, particularly where the device comprises four wheels. Similarly to the power provided to the at least one actuator mechanism detailed above, the one or more wheels may be driven by an electrical power supply. Such a power supply may be provided by one or more of: a battery comprised in the device, the article itself, or an external power supply such as an AC or DC mains power supply. The device may comprise an electrical motor configured to drive the one or more wheels. One or more of braking, slowing, or locking may be applied to the one or more wheels. The braking or slowing may be provided by the electric motor. This solution allows articles to be transported to locations where extra capacity is required temporarily. In this way, one article can be employable with great versatility, thereby addressing capacity requirements at multiple locations throughout a location such as a transportation hub such as an airport.

The device may be configured to be retrofitted to an existing article or kiosk. Existing transportation hubs have installed a wide range of kiosks, and migrating to mobile kiosks would require them to reposition their entire fleet of kiosks. This is a costly, time consuming and environmentally unfriendly process. By providing a device configured to be retrofitted, the device provided allows existing articles to be modified such that they are mobile. For example, customers may be able to modify kiosks already purchased to become mobile. It also allows them to postpone the decision of buying an already mobile kiosk and decide later according to the observed needed capacity. The retrofittable aspect provides a cost-efficient, environmentally friendly and time efficient upgrade of already installed articles.

The device may be configured to be applicable to any existing article. That is, the size and dimensions of the device may be configured such that the device is able to fit to any existing article. The support portion may be unique to each type of article or kiosk or electronic device to which the device is retrofitted.

In some embodiments, the device is retrofitted to an existing article and is intended to be permanently fitted to the article. In this way, the article may be relocated conveniently at any time, and time is not wasted positioning and mounting the device to the article for each use. This may be advantageous for an article which is frequently moved. The device is such that it does not interfere with the article's function, and thus can remain mounted throughout use of the article. In other embodiments, the device may be retrofitted to an article such that the article can be moved, and the device may then be removed from the article. In this way, the same device may be used to relocate a plurality of articles by fitting and removing the device. This may be advantageous as a user may have one or only a few of the devices and would still be able to relocate and transport many articles.

Whilst the device may be retrofittable to an article as explained, it may also be included or integrated into or on a new article or electronic device.

The at least one actuator mechanism may be coupled to the support portion via a side member. The side member may be part of a modular system which makes up the device. That is, the device may form a modular system comprising a plurality of components. The components may non-exhaustively include one or more of: the support portion, the one or more wheels, the at least one actuator mechanism, the housing member, and a power supply such as a battery. The side member may house the at least one actuator mechanism. For example, the at least one actuator mechanism may be housed within the side member. The one or more wheels may be coupled to the support portion via the side member.

The at least one actuator may comprise a substantially planar or flat portion. The substantially planar or flat portion may comprise a rectangular portion and a protruding portion. This may be an L-shaped portion. This portion may wrap around the article in two dimensions. The L-shape reduces the footprint of the article, advantageously allowing it to meet certain requirements, for example, restrictions on occupation of space. Alternatively, the substantially planar or flat portion may be a single rectangular portion. The substantially planar or flat portion may comprise an aperture such as a rectangular aperture through which at least a portion of the at least one actuator mechanism may pass through. For example, the piston portion or linear screw actuator may pass through the aperture. Such an arrangement allows the device to remain compact. The one or more wheels may be coupled to the substantially planar or flat portion. In this way, the at least one actuator mechanism may be in contact with the support portion and the one or more wheels via the substantially planar portion. Actuation of the actuator mechanism may drive movement of the substantially planar portion, or drive movement of the support portion relative to the substantially planar portion. Therefore, when the actuator mechanism is actuated, the support portion is moved related to the one or more wheels.

The device may comprise at least two actuator mechanisms. Preferably, the device comprises two actuator mechanisms. Each of the at least two actuator mechanisms may be actuated independently. The two actuator mechanisms may be situated on opposing sides of the device, and therefore on opposing sides of the article. The opposing sides may be the sides of the device, or the front and rear of the device. The at least one actuator mechanism may be offset from the article. In particular, the actuator mechanism(s) may be offset from the base of the article, or a floor profile of the article. That is, the two actuator mechanisms may be located outside of the body of the article. In this way, actuator mechanism(s) does not provide any increase in height to the article when at rest. The actuator mechanisms may be located substantially towards the base of the article. For example, the two actuator mechanisms may be situated on opposing sides of the article and offset from the body of the article such that, at a resting position, the article maintains its height profile. That is, at a resting position, the actuator mechanisms may not cause any increase in height of the article, other than that resulting from the height of the support portion. This has the benefit that the article height remains largely unchanged even once a device has been fitted to the article.

The at least one actuator mechanism may be wired in parallel. For example, where the device comprises two actuator mechanisms, the two actuator mechanisms are wired in parallel. In this way, the likelihood that the article and device will tip during use is substantially reduced.

The at least one actuator mechanism may be coupled to at least one hinge bracket. The at least one hinge bracket may allow that at least one actuator mechanism to provide the movement of the support portion between the first position to the second position. For example, the at least one actuator mechanism may be coupled to the support portion and to the at least one hinge bracket such that when the at least one actuator mechanism provides actuation, the at least one hinge bracket rotates such that the support portion is moved (i.e. raised or lowered). The at least one actuator mechanism may be coupled to a forward hinge bracket and a rear hinge bracket. The terms forward and rear may refer to the position of the hinge bracket in relation to the device and/or the article. For example, the forward hinge bracket may be situated towards the front of the device and/or article, and the rear hinge bracket may be situated towards the rear of the device and/or article.

The forward and rear hinge brackets may be substantially parallel relative to the plane of the support portion. In this way, when the at least one actuator mechanism is actuated and the support portion is moved relative to the one or more wheels from a first position to a second position or vice versa, the support portion, and thus the device and the article, remains substantially parallel before, during, and after the movement thereby improving stability and safety.

The at least one hinge bracket may have an axis of rotation. The axis of rotation of the at least one hinge bracket may be configured such that the at least a portion of the one or more wheels protrudes past the plane defined by the support portion. As described above, the hinge bracket may facilitate the movement of the support portion. The axis of rotation may be configured such that the movement of the support portion relative to the one or more wheels is such that the one or more wheels can extend and retract beyond the plane of the support portion. In other words, when the device is in the first position, the one or more wheels may be retracted past the plane defined by the support portion. When the device is in the second position, at least a portion of the one or more wheels may be extended beyond the plane defined by the support portion. Alternatively, the one or more wheels may be set outwards from the support portion. For example, the one or more wheels may be protrude outwards away from the support portion like side-wings. In such an embodiment, the axis of rotation of the at least one hinge bracket may be such that one or more wheels are rotated inwards such that the one or more wheels extend beyond the plane of the support portion. Alternatively, the axis of rotation may be towards the front or rear of the article.

In some embodiments, the actuation of the actuator mechanism raising the support portion from first position to a second position does not necessarily lift the article and device onto the support of the one or more wheels. That is, the protrusion of the one or more wheels beyond the plane of the support portion need not raise the device and article onto the one or more wheels. In some embodiments, the support portion may be moved from the first position to the second position such that the one or more wheels are in contact with a surface such as the ground. In such embodiments, the one or more wheels may be located such that, once in contact with the ground, the article and device may be tipped, for example by a user, in order to allow the article and device to be moved. Tipping the article and device may allow the article and device to be supported on the one or more wheels.

The stability of the device is important as the stability of the article may be important. Various aspects of the one or more wheels are important when considering stability. The device may comprise a plurality of wheels. Preferably, the device comprises four wheels. The one or more wheels may comprise one or more caster wheels. The one or more wheels may comprise one or more caster wheels configured to swivel. That is, wheels which are capable of rotating about an axis perpendicular to that of the axis of rotation of the wheel. The one or more wheels may comprise one or more fixed wheels, which may be wheels configured not to swivel, or in other words, to constantly point in the same direction relative to their fixing point. The plurality of wheels may comprise two fixed wheels, and two wheels configured to swivel. Preferably, in such an embodiment, the rear wheels are the wheels configured to swivel. This advantageously provides a device which is easy and convenient to steer, making the device safer and more stable. This also minimizes the use of additional space towards the front of the device and article as the wheels configured to swivel take up more space than fixed wheels. However, in some embodiments, the swivel caster wheels may be positioned towards the front of the device. In another embodiment, the plurality of wheels comprises four wheels, all of which are caster wheels configured to swivel. The plurality of wheels may be positioned such that they are substantially equidistant from the combined center of gravity of the article and the device. This provides great stability and dramatically decreases the likelihood of tipping. If the device comprises other components, such as a battery pack, the wheels may be positioned such that they are in the center of the resultant center of gravity of the article and all components of the device.

The device may be configured to provide and/or establish a communication connection, for example a wireless communication connection. The device may comprise a communication connection hub to provide and/or establish such connections. The communication connection hub may be housed within the housing member. The connections may include a communication connection to a wireless local area network (WLAN) such as a Wi-Fi network. Alternatively or in addition, the communication connection may include a Bluetooth and/or a near-field communication connection. Such communication connections may extend to the article to which the device is coupled. That is, the device may be configured to provide a communication connection such as a wireless communication between the article and an external network and/or device. Here, external means separate from the device and article. In this way, the article and device may be located or relocated to a location unable to facilitate a wired connection to, for example, an internet network. This provides greater flexibility of location for articles.

The device may comprise one or more sensors that detect motion. For example, the device may comprise one or more of an accelerometer or motion sensor. The one or more sensors may be configured to provide data to the article or an external network and/or device to monitor or control the motion of the device. For example, the data may be used to monitor how often the device is used, or to detect the movement of the article and shut down the system if required.

According to another aspect of the invention, there is also provided a method for modifying an article comprising the step of: coupling the device as described in any of the embodiments described above to an article. The coupling the device to the article may comprise the steps of: supporting the article on the support portion; and coupling the at least one actuator to the support portion and to the one or more wheels. The article may be a kiosk or an electronic device, such as a kiosk located at a transportation hub.

### BRIEF DESCRIPTION OF THE DRAWINGS

The invention will now be described in more detail, by way of example, with reference to the accompanying drawings, in which:

FIG. 1a is a schematic diagram of an article fitted with a device embodying an aspect of the present invention;

FIG. 1b is a schematic diagram of an article fitted with a device embodying an aspect of the present invention;

FIG. 2a is a schematic diagram of an actuator mechanism embodying an aspect of the present invention in a first position;

FIG. 2b is a schematic diagram of the actuator mechanism of FIG. 2a in a second position; and

FIG. 3 is a schematic diagram of a device embodying an aspect of the present invention being retrofitted to an article through steps a) to f).

Like features are denoted by like reference numerals.

### DETAILED DESCRIPTION

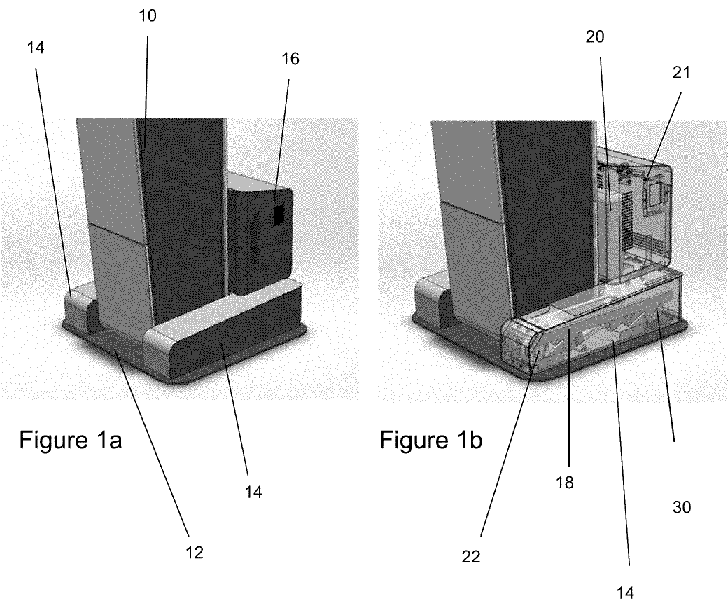

An example device will now be described with reference to FIGS. 1a to 3.

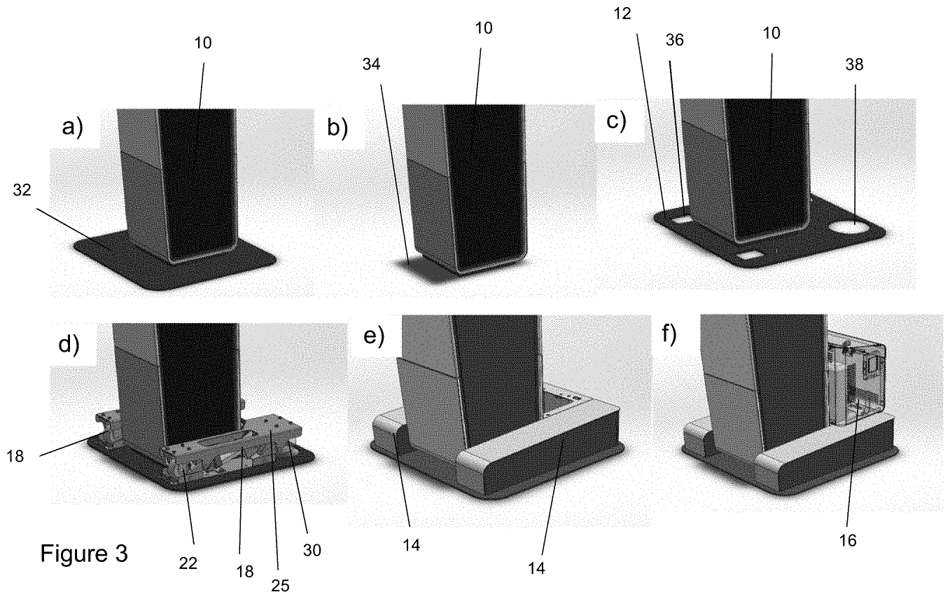

FIG. 1a illustrates an example device coupled to an article. In this example, the article is an airport kiosk 10. The device comprises a support portion, which here is a base plate 12. The support portion supports the kiosk 10. As will be described in more detail with reference to FIG. 3, the kiosk 10 is secured to the base plate 12.

The device comprises side members 14. The side members 14 are situated on opposing sides of the device and of the article. In this example, the side members 14 are situated at the sides of the device, that is, at the sides adjacent to the front and rear of the device. However, it will be understood that the side members 14 could be positioned at the front and rear of the device and article. The device also comprises a rear housing 16.

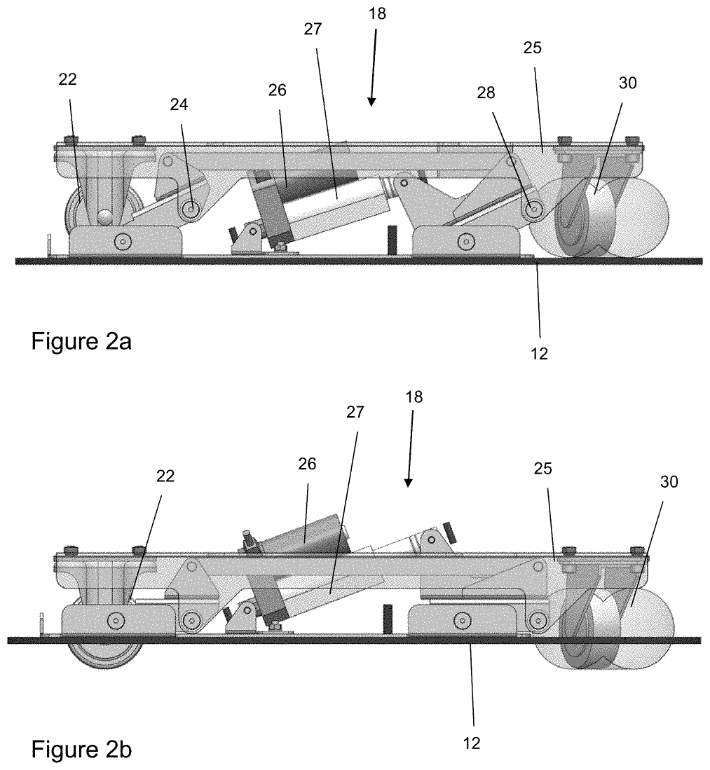

FIG. 1b illustrates the kiosk 10 and the device of FIG. 1a, but illustrates a transparent view of the side member 14, and the rear housing 16. The device comprises two actuator mechanisms 18, which in this example are housed in the side members 14. The actuator mechanisms 18 are coupled to the base plate 12 and are housed in the side members 14. It will be appreciated that the device may comprise more or fewer actuator mechanisms. As will be described in more detail with reference to FIGS. 2a and 2b below, the actuator mechanisms 18 are coupled to one or more wheels. In this example, the device comprises four wheels, including two rear wheels 22 and two front wheels 30. Each of the two actuator mechanisms 18 are coupled to a rear wheel 22 and a front wheel 30.

Significantly, the side members 14, and therefore the actuator mechanisms 18 and the wheels 22, 30 are offset from the base or floor profile of the kiosk 10. In other words, the side members 14 are not under the kiosk 10. In this way, the side members 14, actuator mechanisms 18, and wheels 22, 30 do not increase the height of the kiosk 10 when in a first position or resting position, thus allowing the kiosk 10 to comply with any relevant safety or standard regulations. In this way, the kiosk 10 may be entirely lowered to the ground, without having to remove the device.

The device comprises a battery 20, which in this example is housed within the rear housing 16. The battery 20 provides power supply to the actuator mechanisms 18, to the wheels 22, 30, and to the kiosk 10.

The device also comprises a communication connection hub 21. In this example, the communication connection hub 21 is also housed in the rear housing 16. It will be appreciated that the communication connection hub 21 may be located at any other suitable location on the device. In this example, the communication connection hub 21 is configured to provide and establish one or more wireless communication connections with external networks or devices. For example, the communication connection hub 21 is configured to establish connection over a wireless local area network such as a Wi-Fi network, so may therefore establish a Wi-Fi connection with a wireless network at the airport at which the kiosk 10 is located.

FIG. 2a illustrates one of the two actuator mechanisms 18 of FIG. 1b. In FIG. 2a, the actuator 18 is illustrated in a first position or rest position. The actuator mechanism 18 is coupled to a rear wheel 22 and front wheel 30 via a substantially planar portion 25. In this example, the rear wheels 22 of the device are caster wheels that are fixed wheels. That is, they are not configured to swivel. The front wheels 30 are caster wheels which are configured to swivel.

The actuator mechanism 18 is also coupled to hinge brackets including rear hinge bracket 24 and front hinge bracket 28 via the substantially planar portion 25. Actuation of the actuator mechanism causes the hinge brackets 24, 28 to rotate. The hinge brackets 24 and 28 each have an axis of rotation. The axes of rotation are configured such that rotation of the hinge brackets 24, 28 causes at least a portion of the wheels 22, 30 to protrude beyond a plane defined by the base plate 12 when moving the base plate 12 between the first position and the second position.

With the actuator 18 in the first position, the base plate 12 rests on the floor. The wheels 22, 30 may be in contact with the floor, but do not protrude past the plane defined by the base plate 12, such that the wheels 22, 30 do not raise the device and article at all in the first position.

The rear hinge bracket 24 and the front hinge bracket 28 are substantially parallel relative to the plane define by the base plate 12. Therefore, when the hinge brackets 24, 28 rotate due to actuation of the actuator mechanism, the wheels remain substantially parallel when the base plate 12 is in the second position.

The actuator mechanism 18 is configured to move the base plate 12 relative to the wheels 22, 30 from a first position (illustrated in FIG. 2a) to a second position (illustrated in FIG. 2b). The second position is such that the base plate 12 is raised compared to the first position. The distance between the first position and the second position corresponds to how far the base plate 12 is raised relative to the wheels 22, 30 and in this example is 30 mm.

The actuator mechanism 18 is electrically powered. The power supply is provided by the battery 20. The actuator mechanisms 18 are wired in parallel. In this example, the actuator mechanisms 18 are controlled by user input into the kiosk 10. However, it will be appreciated that the actuator mechanisms 18 may be controlled by any suitable input.

The movement of the base plate 12 relative to the wheels 22 between the first position and the second position is facilitated by a linear screw actuator 27 which is in connection with the support portion 12 and the substantially planar portion 25. The linear screw actuator 27 comprises a nut able to rotate and move along a lead screw, thereby converting rotational motion into linear motion. FIG. 2a illustrates the linear screw actuator 27 in a retracted position. Actuation of the linear screw actuator 27 is provided by an electrical motor 26, which receives power from the battery 20.

FIG. 2b illustrates the actuator mechanism 18 in a second position. The actuator mechanism 18 has been actuated and has moved the base plate 12 to the second position from the first position. That is, electrical power has been provided by the battery 20 to the electric motor 26 which has actuated the linear screw actuator 27, thereby rotating the nut to move it along the lead screw, thus moving the linear screw actuator 27 to an extended position. The movement of the base plate 12 is such that the wheels 22, 30 protrude at least partially beyond the plane defined by the base plate 12, and in this example the wheels 22, 30 protrude at least partially through the base plate 12. The movement of the base plate is such from the first to second position, the wheels 22, 30 protrude perpendicular to the base plate 12, such that the relative motion of the wheels is not in a plane parallel to the movement of the base plate.

An example scenario in which an article is transported or relocated may include the following. There may be an increase in capacity requirement at a particular location in an airport. For example, throughput of travelers may be increased through a particular location, thus it is desirable to provide one or more extra kiosks 10 to said location. This may be during peak hours and therefore a daily variation in capacity, or for example a quarterly change in capacity. A user such as an airport staff member may be requested to relocate one or more kiosks 10. The distance between locations may be significant, such as one kilometer. It may be necessary that in both the starting and end location of the kiosk 10, the kiosk 10 complies with relevant safety standards and requirements of the airport. In this scenario, the device has already been fitted or coupled to the kiosk 10. The process of coupling or fitting the device to the kiosk 10 is described below with reference to FIG. 3.

The user operates the actuator mechanisms 18 via user input on the kiosk 10. The user provides a user input to instruct the actuator mechanisms 18 to raise the base plate 12 from the first position to the second position, the movement being facilitated by the linear screw actuator 27 moving from a retracted position to an extended position. In this position, the kiosk 10 is raised onto the wheels 22, 30 of the device due to the actuator mechanisms 18 rotating the hinge brackets 24, 48. The user then provides another user input via the kiosk 10, to instruct the electrical motor to drive the wheels 22, 30. This provides the mobility of the kiosk 10. The user provides one or more user inputs to control or drive movement of the device and kiosk 10 to the desired location. At such a time that the user is satisfied with the relocation of the kiosk 10, the user may provide a further user input to control the actuator mechanisms 18 to lower the base plate 12 from the second position to the first position. In this way, the base plate 12 rests on the floor or surface on which the kiosk 10 is to be located, and the kiosk 10 is not raised by the wheels 22, 30.

Throughout the movement process including at the original location and the new location, the communication connection hub 21 maintains a wireless communication connection to the airport network, and the battery 20 maintains power supply to the kiosk 10 such that it does not need to be switched off or shut down. Having reached the destination, the kiosk 10 is connected to a mains power supply.

FIG. 3 illustrates the process of retrofitting the device to an existing kiosk 10 including steps a) to f). At step a) the kiosk 10 initially is supported by a base 32, and in this example the kiosk 10 is secured to the base 32 with screws. At step b), the base 32 is removed from the kiosk 10, leaving a gap 34 in order to retrofit the device to the kiosk 10.

At step c), the base plate 12 of the device is secured to the kiosk 10, and in this example is secured with screws. It will be appreciated, however, that the kiosk 10 may instead be secured to the floor, such as through the base plate 12. The base plate 12 comprises wheel apertures. The wheel apertures include rear wheel apertures 36 and front wheel apertures 38. The rear wheel apertures 36 are elongate slit apertures in order to accommodate the fixed caster wheels 22. The front wheel apertures 38 are circular in order to accommodate the swivel caster wheels 30. The apertures (and thus the wheels) are positioned such that they are substantially equidistant from the combined center of gravity of the kiosk 10 and the device.

At step d), the actuator mechanisms 18 are positioned such that the wheels 22, 30 align with their relevant apertures. The actuator mechanisms 18 are positioned on opposing sides of the device and kiosk 10. The substantially planar portions 25 of the actuator mechanisms provide the coupling of the wheels 22, 30 to the actuator mechanism and provide a compact arrangement for the device. At step e), the side members 14 are secured to the base plate 12. The side members 14 house the wheels 22, 30 and the actuator mechanisms 18.

At step f), the rear housing 16 is secured to the device. The rear housing 16 houses the battery 20 and the communication connection hub 21.

The device is thus retrofitted to an existing kiosk 10. The kiosk 10 can then be relocated or transported using the device in the manor described above.

It will be appreciated that in other embodiments, the order of these steps may vary, and indeed some steps may not be required entirely. In some embodiments, the steps a), b), and e) may be implemented consecutively, or steps a), b), and f) may be implemented consecutively. Some kiosks will already have the device fitted and will not require the retrofitting steps. Some kiosks may only require steps d), e), and f) in any suitable order such as d), e), f), or d), f), e). The skilled person will appreciate which steps will be appropriate for a kiosk, and that the order of certain steps may be interchangeable.

Embodiments of the present invention have been described. It will be appreciated that variations and modifications may be made to the described embodiments within the scope of the present invention.

1. A device for moving an article between a first position and a second position, the device comprising: a support portion for supporting an article; one or more wheels; and at least one actuator mechanism coupled to the support portion and the one or more wheels, the at least one actuator mechanism being configured to move the support portion between a first position and a second position, wherein the first position is offset from the second position such that the support portion is raised relative to the one or more wheels when moved from the first position to the second position to allow at least a portion of the one or more wheels to protrude beyond a plane defined by the support portion.

2. A device according to claim 1 wherein the device further comprises one or more side members.

3. A device according to claim 1 wherein the at least one actuator mechanism is coupled to the support portion via one of the one or more side members.

4. A device according to claim 1 or claim 3 wherein the device comprises two actuator mechanisms.

5. A device according to claim 4 wherein two actuator mechanisms are located on opposing sides of the device.

6. A device according to any of claims 1 to 5 wherein the at least one actuator mechanism is offset from the base of the article.

7. A device according to claim 1 wherein the one or more wheels are coupled to the support portion via at least one of the side members.

8. A device according to any of claims 2 to 7 wherein the side members are situated on opposing sides of the device and the article.

9. A device according to any of claims 2 to 8 wherein the one or more side members are offset from the base of the article.

10. A device according to any of claims 1 to 9 wherein the support portion comprises one or more apertures.

11. A device according to claim 10 wherein each of the one or more apertures aligns with each of the one or more wheels.

12. A device according to any of claims 1 to 11 wherein the support portion is substantially flat and preferably wherein the footprint of the support portion is greater than the footprint of the article.

13. A device according to any preceding claim wherein each side portion has a width and wherein the support portion has a width and wherein the ratio of the width of each side portion (14) is between approximately 0.15 and approximately ⅓ of the corresponding width of the support portion (12).

14. A device according to any preceding claim wherein the article has a width and wherein the width of the article is between approximately ⅓ and approximately 1 of the or a corresponding width of the support portion (12).

15. A device according to any preceding claim wherein each side portion has a depth which is greater than a corresponding depth of the kiosk and in particular wherein the depth of each side portion is approximately twice the corresponding depth of the kiosk.

16. A device according to any of claims 1 to 15 wherein the at least one actuator mechanism is coupled to at least one hinge bracket such that actuation of the at least one actuator causes the at least one hinge bracket to rotate.

17. A device according to claim 15 wherein the at least one hinge bracket has an axis of rotation and the axis of rotation of the at least one hinge bracket is configured such that rotation of the at least one hinge bracket causes the at least a portion of the one or more wheels to protrude beyond the plane defined by the support portion.

18. A device according to claim 16 or claim 17 wherein the at least one hinge bracket comprises a forward hinge bracket and a rear hinge bracket.

19. A device according to claim 18 wherein the forward hinge bracket and the rear hinge bracket are substantially parallel relative to the plane of the support portion.

20. A device according to any of claims 1 to 17 wherein the one or more wheels are positioned such that they are substantially equidistant from the combined center of gravity of the article and the device.

21. A device according to any of claims 1 to 20 wherein the distance between the first position and the second position is between 20 mm and 70 mm.

22. A device according to any of claims 1 to 19 wherein the at least one actuator mechanism is electrically powered.

23. A device according to claim 22 wherein the electrical power is provided by one or more of: a battery coupled to the device; the article; or an external AC or DC power supply.

24. A device according to any of claims 1 to 23 wherein the device comprises a battery and the battery provides electrical power to the article.

25. A device according to any of claims 1 to 24 wherein the at least one actuator mechanism is wired in parallel.

26. A device according to any of claims 1 to 25 wherein the device comprises four wheels.

27. A device according to claim 26, wherein the four wheels comprises two fixed wheels and two wheels configured to swivel.

28. A device according to any of claims 1 to 27, further comprising an electric motor configured to drive rotation of the one or more wheels.

29. A device according to any of claims 1 to 28 wherein the device is further configured to provide a wireless communication connection.

30. A device according to claim 29 wherein the wireless communication connection is provided between the article and an external network and/or device.

31. A device according to any of claims 1 to 30 wherein the device is configured to be retrofitted to the article.

32. A device according to any of claims 1 to 31 wherein the device is configured to be attached to the article when the device and article are moved from a first location to a second location and wherein the device is configured to be attached to the article when the at least one actuator mechanism moves the support portion between the first position and the second position.

33. A device according to any of claims 1 to 32 wherein the support portion is coupled to the article with screws.

34. A device according to any of claims 1 to 33 wherein the actuator mechanism comprises a linear screw actuator.

35. A device according to claim 1 wherein in the first position, the one or more wheels do not protrude beyond the plane defined by the support portion, such that the support portion is in contact with the ground.

36. A method of modifying an article comprising the steps of: coupling the device according to any of claims 1 to 35 to an article.

37. A method according to claim 36 wherein the coupling the device to the article comprises the steps of: supporting the article on the support portion; and coupling the at least one actuator to the support portion and to the one or more wheels.

38. A method according to claim 36 or claim 37 wherein the article is a kiosk.

39. A method according to any preceding claim wherein the height of the article is not substantially increased by the device when the support portion is in the first position.

40. A method according to any preceding claim wherein one or more of braking, slowing, or locking is applied to the one or more wheels. 23

41. A method according to any preceding claim wherein the movement of the support portion between the first position and the second position is controlled by user input.

42. A device according to any preceding claim wherein the hinge bracket 24 is coupled to the support portion 12 and wherein each side member 14 is coupled to the hinge bracket 24 via a pivot and preferably wherein the axis of rotation of each wheel is offset from the axis of rotation of the pivot.
